(19) United States
(12) Patent Application Publication
(10) Pub. No.: US 2024/0356709 A1
(43) Pub. Date: Oct. 24, 2024

(54) BEAM MANAGEMENT IN CELLULAR COMMUNICATION NETWORKS

(71) Applicant: Nokia Technologies Oy, Espoo (FI)

(72) Inventors: Timo KOSKELA, Oulu (FI); Keeth Saliya Jayasinghe LADDU, Espoo (FI)

(21) Appl. No.: 18/684,132

(22) PCT Filed: Sep. 22, 2022
(86) PCT No.: PCT/EP2022/076387

§ 371 Date: Feb. 15, 2024

(30) Foreign Application Priority Data
Sep. 30, 2021 (FI) 20216017

(51) Int. Cl. H04L 5/00

(52) U.S. Cl. CPC H04L 5/0053; H04L 5/0048; H04L 5/0094

(57) ABSTRACT

According to an example aspect of the present disclosure, there is provided an apparatus comprising means for determining that the apparatus is configured or activated with at least two Transmission Configuration Indicator, TCI, states for at least one first control resource set and with at least one TCI state for at least one second control resource set and means for selecting at least one Reference Signal, RS, of the at least one first control resource set associated with the at least two TCI states to at least one failure detection resource set and at least one RS of the at least one second control resource set associated with the at least one TCI state to the at least one failure detection resource set.

### FIELD

Various example embodiments relate in general to cellular communication networks and more specifically, to beam management in such networks.

### BACKGROUND

Beam management may refer to a set of functionalities that can be used to enhance operation of beam-based wireless communication systems. Beam management may be used for example in various cellular communication networks, such as, in cellular communication networks operating according to 5G radio access technology. 5G radio access technology may also be referred to as New Radio, NR, access technology. 3rd Generation Partnership Project, 3GPP, develops standards for 5G/NR and one of the topics in the 3GPP discussions is related to beam management. According to the discussions there is a need to provide enhanced methods, apparatuses and computer programs related to beam management in cellular communication networks. Such enhancements may also be beneficial in other wireless communication networks as well.

### SUMMARY

According to some aspects, there is provided the subject-matter of the independent claims. Some example embodiments are defined in the dependent claims.

The scope of protection sought for various example embodiments of the disclosure is set out by the independent claims. The example embodiments and features, if any, described in this specification that do not fall under the scope of the independent claims are to be interpreted as examples useful for understanding various example embodiments of the disclosure.

According to a first aspect of the present disclosure, there is provided an apparatus comprising means for determining that the apparatus is configured or activated with at least two Transmission Configuration Indicator, TCI, states for at least one first control resource set and with at least one TCI state for at least one second control resource set and means for selecting at least one Reference Signal, RS, of the at least one first control resource set associated with the at least two TCI states to at least one failure detection resource set and at least one RS of the at least one second control resource set associated with the at least one TCI state to the at least one failure detection resource set. The apparatus of the first aspect may be a user equipment or a control device configured to control the functioning thereof, possibly when installed therein.

According to a second aspect, there is provided a method comprising, determining, in an apparatus, that the apparatus is configured or activated with at least two Transmission Configuration Indicator, TCI, states for at least one first control resource set and with at least one TCI state for at least one second control resource set and selecting, in the apparatus at least one Reference Signal, RS, of the at least one first control resource set associated with the at least two TCI states to at least one failure detection resource set and at least one RS of the at least one second control resource set associated with the at least one TCI state to the at least one failure detection resource set. The method may be performed by a user equipment or a control device configured to control the functioning thereof, possibly when installed therein.

According to a third aspect of the present disclosure, there is provided an apparatus comprising at least one processing core, at least one memory including computer program code, the at least one memory and the computer program code being configured to, with the at least one processing core, cause the apparatus at least to determine that the apparatus is configured or activated with at least two Transmission Configuration Indicator, TCI, states for at least one first control resource set and with at least one TCI state for at least one second control resource set and select at least one Reference Signal, RS, of the at least one first control resource set associated with the at least two TCI states to at least one failure detection resource set and at least one RS of the at least one second control resource set associated with the at least one TCI state to the at least one failure detection resource set. The apparatus of the third aspect may be a user equipment or a control device configured to control the functioning thereof, possibly when installed therein.

According to a fourth aspect of the present disclosure, there is provided a non-transitory computer readable medium having stored thereon a set of computer readable instructions that, when executed by at least one processor, cause an apparatus to at least to perform the method. According to a fifth aspect of the present disclosure, there is provided a computer program comprising instructions which, when the program is executed by an apparatus, cause the apparatus to carry out the method.

### BRIEF DESCRIPTION OF THE DRAWINGS

FIG. 1 illustrates an example of a network scenario in accordance with at least some embodiments;

FIG. 2 illustrates a first example in accordance with at least some embodiments;

FIG. 3 illustrates a second example in accordance with at least some embodiments;

FIG. 4 illustrates a third example in accordance with at least some embodiments;

FIG. 5 illustrates a fourth example in accordance with at least some embodiments;

FIG. 6 illustrates a fifth example in accordance with at least some embodiments;

FIG. 7 illustrates a sixth example in accordance with at least some embodiments;

FIG. 8 illustrates an example apparatus capable of supporting at least some embodiments;

FIG. 9 illustrates a flow graph of a method in accordance with at least some example embodiments.

### EXAMPLE EMBODIMENTS

Beam management may be enhanced by the procedures described herein. More specifically, beam management may be enhanced by enabling selection of Downlink, DL, Reference Signals, RSs, for failure detection resource set(s) by a User Equipment, UE, when the UE is configured or activated with at least two Transmission Configuration Indicator, TCI, states for at least one first Control Resource Set, CORESET, and also with at least one TCI state for at least one second CORESET. In such a case, different selection rules may be applied by the UE to select RS(s) of the at least one first CORESET and RS(s) of the at least one second CORESET to one set of failure detection resource or multiple sets of failure detection resources, possibly depending on a number of TCI states configured or activated for the at least one second CORESET. Said selection rules may be applied for example for selection of Beam Failure Detection, BFD, RSs and/or Radio Link Monitoring, RLM, RSs.

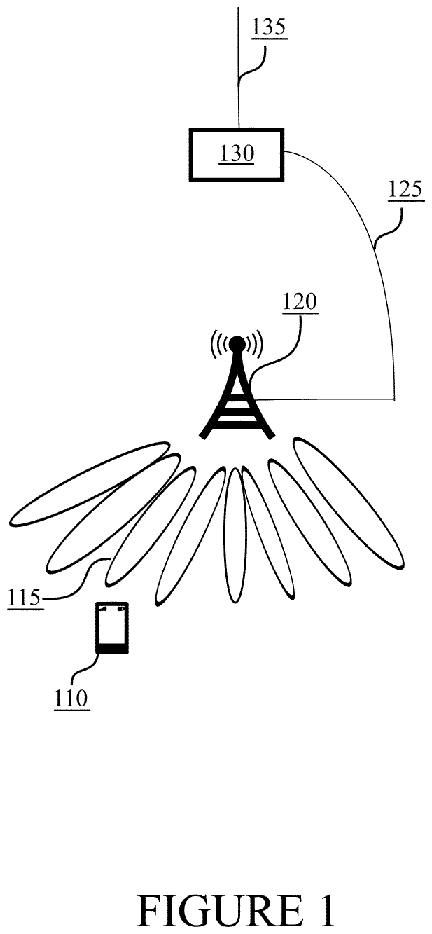

FIG. 1 illustrates an example of a network scenario in accordance with at least some embodiments. According to the example scenario of FIG. 1, there may be a beam-based wireless communication system, which comprises UE 110, wireless network node 120 and core network element 130. UE 110 may be connected to wireless network node 120 via air interface 115 using beams.

UE 110 may comprise, for example, a smartphone, a cellular phone, a Machine-to-Machine, M2M, node, Machine-Type Communications, MTC, node, an Internet of Things, IoT, node, a car telemetry unit, a laptop computer, a tablet computer or, indeed, any kind of suitable wireless terminal. In the example system of FIG. 1, UE 110 may communicate wirelessly with wireless network node 120 via air interface 115. Wireless network node 120 may be considered as a serving node for UE 110 and one cell of wireless network node 120 may be a serving cell for UE 110.

Air interface 115 between UE 110 and wireless network node 120 may be configured in accordance with a Radio Access Technology, RAT, which both UE 110 and wireless network node 120 are configured to support. Examples of cellular RATs include Long Term Evolution, LTE, New Radio, NR, which may also be known as fifth generation, 5G, radio access technology and MulteFire.

For example in the context of LTE, wireless network node 120 may be referred to as eNB while wireless network node 120 may be referred to as gNB in the context of NR. In some example embodiments, wireless network node 120 may be referred to as a Transmission and Reception Point, TRP, or control multiple TRPs that may be co-located or non-co-located. In any case, example embodiments of the present disclosure are not restricted to any particular wireless technology. Instead, example embodiments may be exploited in any beam-based wireless communication system, wherein beam management would be beneficial. For instance, example embodiments of the present disclosure may be exploited for Beam Failure Recovery, BFR, configuration, e.g., for single frequency network operation.

Wireless network node 120 may be connected, directly or via at least one intermediate node, with core network 130 via interface 125. Core network 130 may be, in turn, coupled via interface 135 with another network (not shown in FIG. 1), via which connectivity to further networks may be obtained, for example via a worldwide interconnection network. Wireless network node 120 may be connected, directly or via at least one intermediate node, with core network 130 or with another core network.

In some example embodiments, the network scenario may comprise a relay node instead of, or in addition to, UE 110 and/or wireless network node 120. Relaying may be used for example when operating on millimeter-wave frequencies. One example of the relay node may be an Integrated Access and Backhaul, IAB, node. The IAB node may be referred to as a self-backhauling relay as well. Another example of a relay may be an out-band relay. In general, the relay node may comprise two parts:
1) Distributed Unit, DU, part which may facilitate functionalities of wireless network node 120, such as a gNB. Thus, in some example embodiments, the DU part of a relay may be referred to as wireless network node 120 and the DU may perform tasks of wireless network node 120;
2) Mobile Termination, MT, part which may facilitate functionalities of UE 110, i.e., a backhaul link which may be the communication link between a parent node (DU), such as a DU part of wireless network node 120, and the relay, such as an IAB node. In some example embodiments, the MT part may be referred to as UE 110 and perform tasks of UE 110.

At least some example embodiments of the present disclosure may be exploited for Further enhanced Multiple-Input Multiple-Output, FeMIMO, currently being standardized by the 3rd Generation Partnership Project, 3GPP. For instance, example embodiments of the present disclosure may be exploited for enhancing multi-beam operation, by supporting inter-cell beam management.

In case of inter-cell beam management, UE 110 may be configured to communicate with more than one cell, e.g., with a serving cell and one or more cell that has different Physical Cell Identifier, PCI, than the serving cell. Furthermore, UE 110 may transmit to, or receive from, only one single cell, i.e. the serving cell may not change when beam selection is done for the cell with the different PCI than the serving cell. In some example embodiments, UE 110 may be configured to receive common channels from the serving cell and dedicated channels from the cell with the different PCI than the serving cell. In some example embodiments, UE 110 may be configured to transmit in uplink to the cell with the different PCI than the serving cell and receive in downlink (dedicated and/or common channels) from the serving cell, and vice versa. Inter-cell beam management may include layer 1 measurement and reporting only, without any layer 3 impact, and beam indication associated with cell(s) with any Physical Cell Identifier, PCIs. Beam indication may be based on a unified TCI framework, such as the unified TCI framework defined in Rel-17 3GPP standard specification. In some example embodiments, the same beam measurement/reporting mechanism may be reused for inter-cell multi-TRP operation. In some example embodiments, only intra-DU and intra-frequency cases may be considered. In some example embodiments, the inter-cell beam management may refer to operation where the serving cell does not change for UE 110 but it can be configured to communicate with the cell with the different PCI in dynamic manner (sometimes referred to as Dynamic Point Selection, DPS).

Quasi Co-Location, QCL, indication functionality may be exploited for beam management. Two antenna ports may be considered as QCL'ed if properties of a channel over which a symbol is transmitted via a first antenna port can be derived from channel over which a symbol is transmitted via a second antenna port. Regarding downlink beam indication, QCL indication functionality may be defined as follows. The principle to receive a certain physical signal or physical channel may be that UE 110 is either configured with, or UE 110 implicitly determines, a source/reference RS that UE 110 has received and measured earlier which defines how to set a receive beam of UE 110 for the reception of the downlink (target) physical signal or channel to be received. To provide UE 110 with QCL characteristics for the target signal (to be received) a TCI framework may be used.

According to the TCI framework, UE 110 may be configured with TCI state(s) to provide UE 110 with source RS(s) for determining QCL characteristics. Each TCI state may include for example one or two source RSs that provide QCL TypeA, TypeB, TypeC and/or TypeD parameters to UE 110, e.g., as follows:
QCL-TypeA: {Doppler shift, Doppler spread, average delay, delay spread}
QCL-TypeB: {Doppler shift, Doppler spread}
QCL-TypeC: {Doppler shift, average delay}
QCL-TypeD: {Spatial Rx parameter}

In some example embodiments, BFD procedures may be enhanced, such as the BFD procedure defined in the 3GPP standard specification TS 38.213. As defined therein, in case of an implicit configuration a RS, such as a Channel State Information-Reference Signal, CSI-RS, indicated by an active TCI state with qcl-typeD for a CORESET may be included into the set of q0, i.e., the BFD-RS set.

In addition, or alternatively, RLM procedures may be enhanced. A downlink radio link quality of a primary cell may be monitored by a UE for the purpose of indicating out-of-sync/in-sync status to higher layers. The UE may not be required to monitor the downlink radio link quality in downlink bandwidth parts other than the active downlink bandwidth parts on the primary cell though. If the active downlink bandwidth parts is the initial downlink bandwidth parts and for Synchronization Signal, SS, Physical Broadcast Channel, PBCH, block and CORESET multiplexing pattern 2 or 3, the UE may be expected to perform RLM using the associated SS/PBCH block when the associated SS/PBCH block index is provided by RadioLinkMonitoringRS.

For instance, according to 3GPP standard specification TS 38.213, if UE 110 is not provided RadioLinkMonitoringRS and UE 110 is provided for Physical Downlink Control Channel, PDCCH, receptions TCI states that include one or more of a CSI-RS, UE 110 may use for radio link monitoring the RS provided for the active TCI state for PDCCH reception if the active TCI state for PDCCH reception includes only one RS. If the active TCI state for PDCCH reception includes two RS, UE 110 may expect that one RS is configured with qcl-Type set to ‘typeD’ and use the RS configured with qcl-Type set to ‘typeD’ for radio link monitoring but UE 110 may not expect both RS to be configured with qcl-Type set to ‘typeD’. UE 110 may not be required to use for radio link monitoring an aperiodic or semi-persistent RS though.

Moreover, it has been agreed in the 3GPP RAN1 standardization group that in enhancements on High Speed Train, HST, —Single Frequency Network, SFN, deployment track, that if enhanced SFN PDCCH transmission scheme (scheme 1 or TRP-based pre-compensation) is configured and two TCI states are activated for at least one CORESET, an implicit configuration of RS for BFD should be supported. The implicit configuration should enable RSs of CORESETs with both single and two TCI states. Also, a maximum number of BFD RSs and details on RS determination should be defined. In addition, it has been agreed in the 3GPP RAN1 standardization group that in case of multi-TRP track BFD-RS configurations for UEs with one activated TCI state per CORESET should be supported along with explicit configuration of BFD-RS resources and CORESETs with more than 1 activated TCI state. Therefore, the 3GPP RAN1 standardization group has agreed that a scenario should be supported, wherein one or more CORESETs can be activated with one or two TCI states and for implicit BFD-RS configuration, the RS of both single and two TCI states may be used.

The challenge though is that it is not defined how a UE should be configured to select BFD-RS that may be included to the set of q0, i.e., BFD-RS set, in a scenario where the UE may be potentially configured with two types of TCI state activation for CORESET(s) and the maximum number of BFD-RS may be exceeded (more RSs as some CORESETs can be also associated to two TCI states) by the implicit BFD-RS configuration. Similar challenges may arise in case of other failure detection RSs as well, such as RLM RSs.

Example embodiments of the present disclosure therefore make it possible to avoid exceeding the maximum number of RSs to be included into a failure detection RS set (for BFD or for RLM). More specifically, in some example embodiments, UE 110 may first determine that it is configured or activated with at least two TCI states for at least one first CORESET and with at least one TCI for at least one second CORESET. UE 110 may then select, i.e., include at least one RS of the first CORESET associated with at least two TCI states to at least one failure detection RS set, such as BFD RS set or RLM RS set, and at least one RS of the at least one second CORESET associated with the at least one TCI state to the at least one failure detection RS set as well. In accordance with the following example embodiments, said selection may depend on whether UE 110 is configured with one failure detection RS set or more than one failure detection RS set. In some example embodiments, a failure detection RS set may be referred to as a failure detection resource set as well. In some example embodiments, a set of q0 may be used to refer to a failure detection RS set. In some example embodiments, it may refer to beam failure detection reference signal set. In some example embodiments, there may be one or more of failure detection RS sets.

In some example embodiments, said selection may further depend on whether UE 110 is configured, or activated, with one or more than one TCI state for the at least one second CORESET. Alternatively, or in addition, said selection may comprise selecting a maximum number of RSs to the at least one failure detection resource set. Even though various example embodiments are described using BFD RSs as an example of failure detection RSs, example embodiments of the present disclosure may be applied similarly for any suitable failure detection RSs, such as RLM RSs.

In any of the example embodiments, if there are two QCL source RS indicated by one TCI state UE 110 may select for BFD and/or RLM the RS that provides the qcl-typeD source in the TCI state. In case there are two TCI states (and each TCI state has 2 QCL source RS) activated for a CORESET, UE 110 may select the qcl-typeD RS per respective TCI state.

In some example embodiments, UE 110 may be configured with one failure detection resource set (e.g. for BFD) or UE 110 may assume that only one failure detection resource set is used (e.g., for BFD or for RLM). In some example embodiments, UE 1110 may assume that for RLM purposes, only one set is used. In some example embodiments, UE 110 may assume that one or more failure detection resource sets are used (e.g. for BFD).

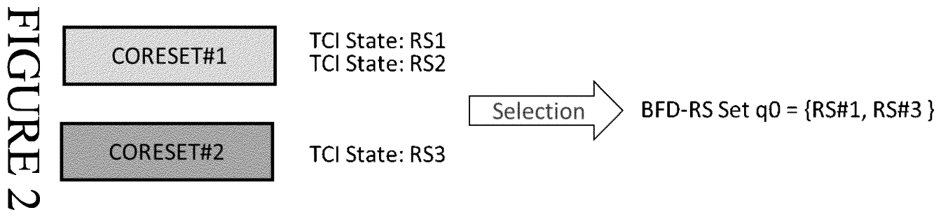

FIG. 2 illustrates a first example in accordance with at least some embodiments. According to the first example, UE 110 may be configured with one BFD RS set. That is, UE 110 may first determine that it is configured with one BFD RS set. After that, UE 110 may determine that it is configured or activated with one TCI state for the at least one second CORESET and select the RS of the at least one second CORESET associated with the at least one TCI state to the BFD RS set. UE 110 may also select one RS of the at least one first CORESET associated with the at least two TCI states to the same BFD RS set. That is, for example two TCI states may indicate two RSs and UE 110 may select one of said two RSs.

For instance, if there are two active TCI states for the at least one first CORESET and at least one active TCI state for the at least one second CORESET, UE 110 may determine to include up to a maximum number of BFD RSs, such as qcl-typeD RSs, indicated by the active TCI state(s) for the CORESET to the set of q0 by selecting a RS the second CORESET associated with one active TCI State to the set and then including one (qcl-typeD) RS of the first CORESETs associated with two active TCI states to the same set. That is, in some example embodiments, UE 110 may select the RS of the second CORESET with one active TCI state and select QCL-typeD RS of either of the TCI states of the first CORESET(s), when the first CORESET(s) are associated with two TCI states. However, in some example embodiments, the order of selection/inclusion may not matter.

In some example embodiments, UE 110 may select first the RS of a CORESET(s) with one active TCI state and then select QCL-typeD RS of either of the TCI states of the CORESET(s), when the first CORESET(s) are associated with two TCI states, up to maximum number of failure detection resources.

In some example embodiments, UE 110 may first select QCL-typeD RS of either of the TCI states of the CORESET(s), when the CORESET(s) are associated with two TCI states and then UE 110 may select the RS of a CORESET(s) with one active TCI state, up to maximum number of failure detection resources.

In some example embodiments, if multiple CORESETs have two TCI states, UE 110 may include to the set a RS indicated by one of the active TCI states of each CORESET, until a maximum number of BFD RSs are selected.

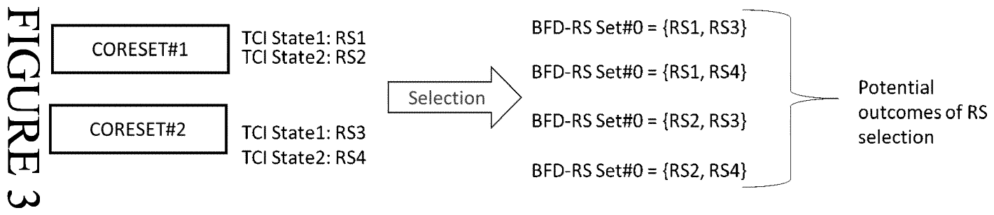

FIG. 3 illustrates a second example in accordance with at least some embodiments. According to the second example, UE 110 may be configured with one BFD RS set. That is, UE 110 may first determine that it is configured with one BFD RS set. After that, UE 110 may determine that it is configured or activated with at least two active TCI states for the at least one second CORESET and select one RS per each CORESET associated with at least two active TCI states to the BFD RS set. Thus, UE 110 may select one RS per each CORESET of the at least one first and the at least one second CORESETs, i.e., UE 110 may select one RS per each CORESET associated with two active TCI states.

For instance, if there are two CORESETs with two active TCI states, UE 110 may determine to include up to a maximum number of BFD RSs, such as qcl-typeD RSs, indicated by the active TCI state(s) for the CORESET to the set of q0 so that UE 110 selects one RS per each CORESET. In some example embodiments, the selected RSs may have different source RSs, i.e., the source Synchronization Signal Block, SSB, may be different for all the selected RSs that are included to the set of q0.

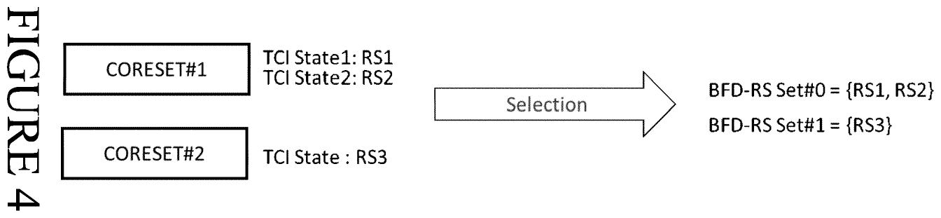

FIG. 4 illustrates a third example in accordance with at least some embodiments. According to the third example, UE 110 may be configured with more than one BFD RS set, i.e., a configuration of (temporarily) multiple BFD RS sets is considered. That is, UE 110 may first determine that it is configured with more than one BFD RS set. After that, UE 110 may determine that it is configured with more than one BFD RS set and select the at least one RS of the at least one first CORESET associated with the at least two TCI states to a BFD RS set and at least one RS of the at least second CORESET associated with the at least one TCI state to another BFD RS set. UE 110 may hence determine to monitor beam failure on two RS sets, where one BFD RS set includes the RS of the second CORESET associated with one TCI state and another BFD RS set includes the RS(s) of the first CORESET(s) associated with two active TCI states.

In some example embodiments, the maximum number of BFD-RS may be per BFD-RS set or across one or more BFD-RS sets or per respective BFD-RS set (e.g. across two sets in total or individually for each of the sets).

For instance, if there are two active TCI states for at least one first CORESET and at least one active TCI state for at least one second CORESET, UE 110 may determine to monitor the beam failure on multiple sets so that the RS indicated by the active TCI state for the second CORESET associated with one TCI state is included in one set of q0 (e.g. #0) and the one, or both RSs, indicated by the two activate TCI states for the first CORESET is included in another set of q0.

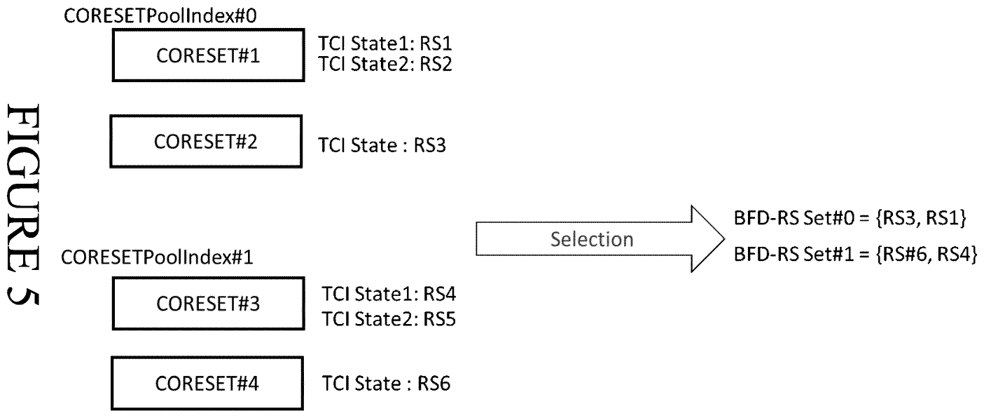

FIG. 5 illustrates a fourth example in accordance with at least some embodiments. According to the fourth example, UE 110 may be configured with more than one BFD RS set, i.e., a configuration of for example two sets #0 and #1 is considered. That is, UE 110 may first determine that it is configured with more than one BFD RS set. After that, UE 110 may determine that at least some of the configured or activated CORESETs are under, i.e. have, a same CORESET pool index (CORESETPoolIndex) and select the at least one RS of the at least one second CORESET associated with the at least one TCI state to at least one BFD RS set first and then the at least one RS of the at least one first CORESET associated with at least two TCI states to the at least one BFD RS set per the CORESETs of the same control resource set pool index.

That is, UE 110 may first select the RS of the second CORESET associated with one active TCI state and then select a QCL-typeD RS of either of the TCI states of the first CORESET(s) associated with two TCI states. Said selection may be done per within the CORESETs of the same CORESET pool index such that UE 110 may determine that at least one of the at least one CORESET is under the same CORESET pool index as at least one of the at least one second CORESET and select at least one RS of said one of the at least one second CORESET associated with the at least one TCI state to one BFD RS set first and then select at least one RS of said one of the at least one first CORESET associated with at least two TCI states to said one BFD RS set.

For instance, within the CORESETs under the same CORESET pool index, if there are two active TCI states for at least one first CORESET and at least one active TCI state for at least one second CORESET, UE 110 may determine to include maximum number of BFD RSs, such as qcl-typeD RSs, indicated by the active TCI state(s) for the CORESET to the set of q0. UE 110 may first select the RS of the second CORESET associated with one active TCI State to the set and then also include one RS of the first CORESET(s) associated with two active TCI states to the set. In some example embodiments, if multiple CORESETs are associated with two TCI states, UE 110 may include a RS indicated by one of the active TCI states for each CORESETs, until a maximum number of RSs is selected.

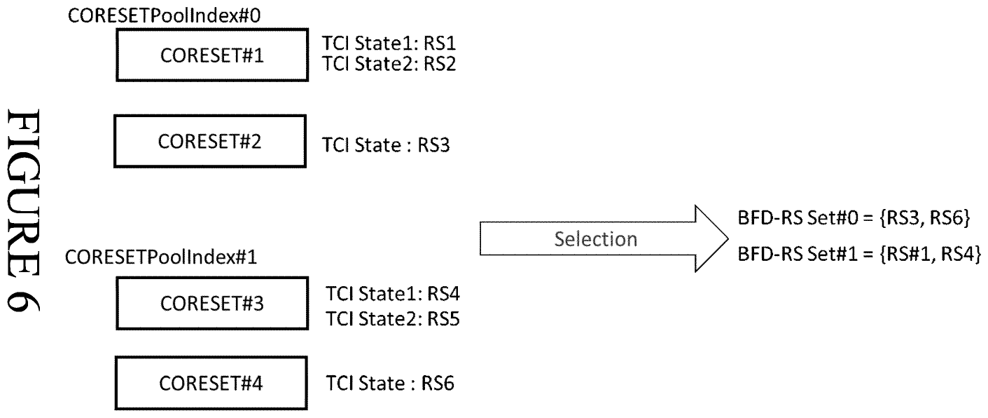

FIG. 6 illustrates a fifth example in accordance with at least some embodiments. More specifically, the fifth example is about a Multi-Downlink Control Information, M-DCI, multi-TRP scenario, wherein two BFD RS sets may be configured (e.g., sets #0 and #1) and there may be two first CORESETs associated with two active TCI states and two second CORESETs associated with one active TCI State.

In a multi-DCI multi-TRP scenario, UE 110 may determine that it is configured with more than one BFD RS set. After that, UE 110 may determine that it is configured or activated with at least two TCI states for at least two first CORESETs and with one TCI state for at least two second CORESETs. UE 110 may then select the RSs of the at least two second CORESETs associated with said one TCI state to a BFD RS set and one RS per each of the at least two first CORESETs associated with the at least one TCI state to another BFD RS set.

In some example embodiments, UE 110 may determine to include to one set (of q0) the RS indicated by the active TCI states of the second CORESET(s) associated with one TCI state across CORESET pool index values, and to another set (of q0) the one RS indicated by the active TCI state per each first CORESET associated with two active TCI states. Therefore, separate recovery for multi-DCI mode or SFN mode may be allowed, e.g., depending on a network configuration, i.e., whether to follow CORESET pool index approach (i.e. when UE 110 is configured with more than one CORESETpool index value may have two failure detection resource sets) or SFN type approach (wherein e.g. UE 110 would assume two failure detection resource sets based implicit assumptions e.g. the configuration of two TCI states for at least one CORESET), wherein a CORESET may have one or two active TCI states for BFD RS selection.

For instance, UE 110 may consider the RS selection across the CORESETs of the same and different CORESET pool index values, so that UE 110 may select the RS (indicated by the active TCI states) for a second CORESET associated with one active TCI state to be included in the same BFD RS set and then select QCL-typeD RS of either of the TCI states of the first CORESET(s) associated with two TCI states. Said selection may be done per within the CORESETs of same CORESETpoolIndex).

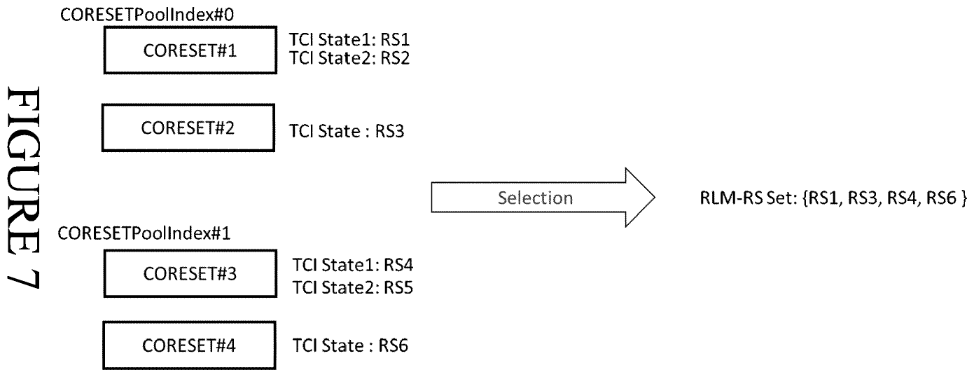

FIG. 7 illustrates a sixth example in accordance with at least some embodiments. The sixth example is about RLM RS selection. In general, the selection rules of the present disclosure may be applied for implicit RLM RS selection similarly as BFD RS selection. That is, the examples illustrated in FIGS. 2 to 6 may be applied similarly for selection of any other failure detection resource set, such as RLM RS set. Similarly, the sixth example illustrated in FIG. 7 may be applied for selection of any other failure detection resource set, such as BFD RS set.

In some example embodiments, RLM RS selection may have its own set of rules and BFD RS selection may have its own selection rules.

In some example embodiments, these rules may be jointly configured/used. Alternatively, the implicit selection of RLM RS may be configured independently from BFD RS. In some example embodiments, when UE 110 is configured with CORESETs associated with two active TCI states, UE 110 may include one RS per each CORESET to the set of RLM RSs for radio link monitoring. In some example embodiments, when UE 110 is configured with CORESETs associated with one and two active TCI states for respective CORESETs, UE 110 may also include one RS per each CORESET to the set of RLM-RS for radio link monitoring. In some example embodiments, if more than one CORESET pool index values is configured, UE 110 may select the RLM RS based on the CORESET pool index where a CORESET #0 is associated and then UE 110 may perform the selection of RLM RS on the CORESETs on that pool index.

As another example, the first CORESET may be associated with two RSs (one with PCI #1 and another with PCI #2) and the second CORESET may be associated with one RS (PCI #1). The first RS set may have PCI #1 RSs (from the first and the second CORESETs) and the second RS set may have PCI #2 RS (from the first CORESET). That is, the second CORESET may be associated with one RS and a first PCI and the first CORESET may be associated with two RSs, and a first of said two RSs may be further associated with the first PCI and a second of said two RSs may be further associated with a second PCI, and a first failure detection resource set may have the RSs associated with the first PCI and a second failure detection resource set may have the RS associated with the second PCI.

In some example embodiments, the reference signal selection/inclusion to a failure detection set may additionally or alternatively consider the inter-cell aspect i.e. a case where UE configured to communicate with the serving cell and another cell (with different PCI than serving cell). This inter-cell configuration may refer to inter-cell mTRP and/or inter-cell beam management. In some example embodiments, at least one CORESET may be associated with at least one RS of PCI #1 (i.e. active TCI state for CORESET indicates RS associated with PCI #1) and at least one CORESET may be associated with at least one RS associated with PCI #2 (i.e. active TCI state for CORESET indicates RS associated with PCI #2). In this case UE 110 may determine to include in the failure detection RS set (RLM-RS and/or BFD-RS) the (qcl-typeD) RS associated with a PCI that is configured for the serving cell. In other words, UE 110 may determine to perform RLM on the RS of the PCI that is configured as the serving cell (e.g. PCI #1). As an example, in implicit RLM-RS configuration UE 110 may include only the RS indicated by the active TCI state(s) of the serving cell (e.g. PCI #1) to the set of RLM-RS. Alternatively, or additionally, UE 110 may include the RS indicated by the active TCI state(s) for CORESETs with Common Search Space, CSS, of the serving cell (e.g. PCI #1) to the set of RLM-RS. In some example embodiments, in case the active TCI State for a CORESET indicates an RS associated with a PCI different from the serving cell, UE 110 may not include the RS to the set of failure detection resources (for RLM or BFD). Similarly in case of explicit configuration of RLM-RS UE 110 may assume that only serving cell (e.g. PCI #1 where the another cell configured for communication has different PCI than serving cell) RS are configured RLM purposes or UE 110 may determine not to monitor the RS associated with different PCI than serving cell for RLM. In some example embodiments, UE 110 may be configured to include into (one) BFD-RS set the RS indicated by the TCI states for respective CORESETs with PCI #2 (e.g. that is not the serving cell). As a further example, for BFD UE 110 may determine to include to the RS indicated by the active TCI states In yet another example embodiment, UE 110 may be configured to include RS indicated by the active TCI states for CORESETs associated with PCI #1 (the serving cell) to one BFD-RS set and the RS indicated by the TCI States for CORESETs associated with PCI #2 to another BFD-RS set. In some example embodiments, UE 110 may perform RLM on PCI #1 (serving cell) only but perform beam failure detection on cells with PCI #1 and PCI #2 (serving cell and a cell with a PCI that is different than serving cell PCI).

In some example embodiments, UE 110 may determine that CORESETs may be associated with at least two different PCIs i.e. the CORESETs have been configured with active TCI states indicating RS from two different PCIs (and one PCI may be the serving cell PCI). In an example embodiment, UE 110 may monitor beam failure on the RSs associated with PCI that is different from serving cell indicated by the active TCI state(s) (qcl-typeD RS of the TCI state if two are present). In one example embodiment, when UE 110 is configured with active TCI states for CORESETs indicating RS associated with serving cell PCI and PCI from another cell, UE 110 may monitor beam failure on the RSs associated with PCI that is different from serving cell indicated by the active TCI state(s) (qcl-typeD RS of the TCI state if two are present).

In any of the embodiments described herein, the RSs included into the set may be SSB or CSI-RS.

In any of the embodiments described herein, if the CORESET is associated with a certain PCI (cell identifier) it may mean that the CORESET has an active TCI state which indicates an RS that is associated with the said PCI (cell identifier). RS can be considered to be associated with specific PCI if the indication is explicit i.e. SSB #1-PCI #1 or if a RS has a QCL source that is associated with a PCI i.e. CSI-RS->SSB #1-PCI1. The cell identifier used for the association may be the exact value of Physical Cell Identifier or an re-indexed value (PCI #1=53->PCI_reindex=1 and PCI #2=75->PCI_reindex=2 and so on.) In some example embodiments, if the activated TCI states (one or both TCI states) of the first and second CORESETs are associated with more than one PCI, UE 110 may select RSs for each BFD RS set by including the RSs associated with the same PCI to the same set.

As an alternative, or in addition to, any of the preceding example embodiments, if there are two active TCI states for a CORESET, and both are not, or cannot be selected, UE 110 may select the RS (indicated by the TCI states) with shorter periodicity. As an example, RS #1 (e.g. providing the qcl-typeD information) indicated by the TCI State 1 has periodicity 20 ms and RS #2 (e.g. providing the qcl-typeD information) indicated by the TCI State 2 has periodicity of 10 ms UE may select the RS #2. This may be beneficial for measurement (failure detection) purposes, providing UE 110 with more opportunities for measurement and therefore allowing UE 110 to perform other tasks (e.g. receiving data) while being able to measure/monitor the RS for failure detection. This in turn may improve communication efficiency and throughput. In case of equal periodicity UE 110 may select RS with lower codepoint index.

As an alternative, or in addition to, any of the preceding example embodiments, UE may select the RS (indicated by the TCI state(s)) based on the ascending or descending order of the CORESET index value. CORESET index value may be considered for CORESETs within the same CORESETPoolindex value or across the CORESETpoolindex values. As an example, UE may select per each CORESET, starting from the lowest (or highest) CORESET index, at least on RS (indicated by the active TCI state) according to any example embodiments herein until up to the maximum number of BFD-RS are selected (for one set or for both sets). The selection may be applied for current active bandwidth part (downlink). UE starts the selection from the lowest index (or highest) CORESET index and may select at least one RS per each CORESET (e.g. if UE is configured with 3 CORESETs (with indexes #1, #2, #3) and the maximum number of BFD-RS is two UE select RS from CORESETs #1 and #2).

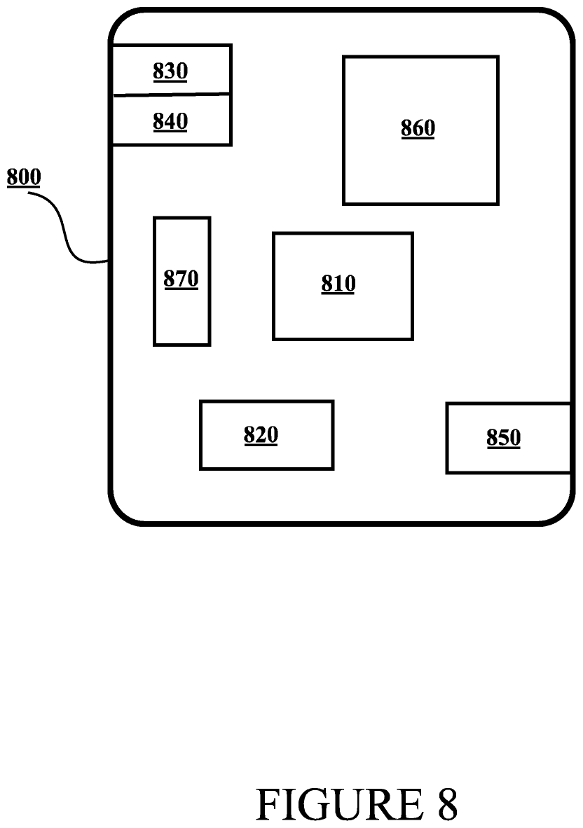

FIG. 8 illustrates an example apparatus capable of supporting at least some embodiments. Illustrated is device 800, which may comprise, for example, UE 110 or wireless network node 120, or a control device configured to control the functioning thereof, possibly when installed therein. Comprised in device 800 is processor 810, which may comprise, for example, a single- or multi-core processor wherein a single-core processor comprises one processing core and a multi-core processor comprises more than one processing core. Processor 810 may comprise, in general, a control device. Processor 810 may comprise more than one processor. Processor 810 may be a control device. A processing core may comprise, for example, a Cortex-A8 processing core manufactured by ARM Holdings or a Steamroller processing core produced by Advanced Micro Devices Corporation. Processor 810 may comprise at least one Qualcomm Snapdragon and/or Intel Atom processor. Processor 810 may comprise at least one application-specific integrated circuit, ASIC. Processor 810 may comprise at least one field-programmable gate array, FPGA. Processor 810 may be means for performing method steps in device 800. Processor 810 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 800 may comprise memory 820. Memory 820 may comprise random-access memory and/or permanent memory. Memory 820 may comprise at least one RAM chip. Memory 820 may comprise solid-state, magnetic, optical and/or holographic memory, for example. Memory 820 may be at least in part accessible to processor 810. Memory 820 may be at least in part comprised in processor 810. Memory 820 may be means for storing information. Memory 820 may comprise computer instructions that processor 810 is configured to execute. When computer instructions configured to cause processor 810 to perform certain actions are stored in memory 820, and device 800 overall is configured to run under the direction of processor 810 using computer instructions from memory 820, processor 810 and/or its at least one processing core may be considered to be configured to perform said certain actions. Memory 820 may be at least in part comprised in processor 810. Memory 820 may be at least in part external to device 800 but accessible to device 800.

Device 800 may comprise a transmitter 830. Device 800 may comprise a receiver 840. Transmitter 830 and receiver 840 may be configured to transmit and receive, respectively, information in accordance with at least one cellular or non-cellular standard. Transmitter 830 may comprise more than one transmitter. Receiver 840 may comprise more than one receiver. Transmitter 830 and/or receiver 840 may be configured to operate in accordance with Global System for Mobile communication, GSM, Wideband Code Division Multiple Access, WCDMA, Long Term Evolution, LTE, and/or 5G/NR standards, for example.

Device 800 may comprise a Near-Field Communication, NFC, transceiver 850. NFC transceiver 850 may support at least one NFC technology, such as Bluetooth, Wibree or similar technologies.

Device 800 may comprise User Interface, UI, 860. UI 860 may comprise at least one of a display, a keyboard, a touchscreen, a vibrator arranged to signal to a user by causing device 800 to vibrate, a speaker and a microphone. A user may be able to operate device 800 via UI 860, for example to accept incoming telephone calls, to originate telephone calls or video calls, to browse the Internet, to manage digital files stored in memory 820 or on a cloud accessible via transmitter 830 and receiver 840, or via NFC transceiver 850, and/or to play games.

Device 800 may comprise or be arranged to accept a user identity module 870. User identity module 870 may comprise, for example, a Subscriber Identity Module, SIM, card installable in device 800. A user identity module 870 may comprise information identifying a subscription of a user of device 800. A user identity module 870 may comprise cryptographic information usable to verify the identity of a user of device 800 and/or to facilitate encryption of communicated information and billing of the user of device 800 for communication effected via device 800.

Processor 810 may be furnished with a transmitter arranged to output information from processor 810, via electrical leads internal to device 800, to other devices comprised in device 800. Such a transmitter may comprise a serial bus transmitter arranged to, for example, output information via at least one electrical lead to memory 820 for storage therein. Alternatively to a serial bus, the transmitter may comprise a parallel bus transmitter. Likewise processor 810 may comprise a receiver arranged to receive information in processor 810, via electrical leads internal to device 800, from other devices comprised in device 800. Such a receiver may comprise a serial bus receiver arranged to, for example, receive information via at least one electrical lead from receiver 840 for processing in processor 810. Alternatively to a serial bus, the receiver may comprise a parallel bus receiver.

Device 800 may comprise further devices not illustrated in FIG. 8. For example, where device 800 comprises a smartphone, it may comprise at least one digital camera. Some devices 800 may comprise a back-facing camera and a front-facing camera, wherein the back-facing camera may be intended for digital photography and the front-facing camera for video telephony. Device 800 may comprise a fingerprint sensor arranged to authenticate, at least in part, a user of device 800. In some example embodiments, device 800 lacks at least one device described above. For example, some devices 800 may lack a NFC transceiver 850 and/or user identity module 870.

Processor 810, memory 820, transmitter 830, receiver 840, NFC transceiver 850, UI 860 and/or user identity module 870 may be interconnected by electrical leads internal to device 800 in a multitude of different ways. For example, each of the aforementioned devices may be separately connected to a master bus internal to device 800, to allow for the devices to exchange information. However, as the skilled person will appreciate, this is only one example and depending on the example embodiment various ways of interconnecting at least two of the aforementioned devices may be selected without departing from the scope of the example embodiments.

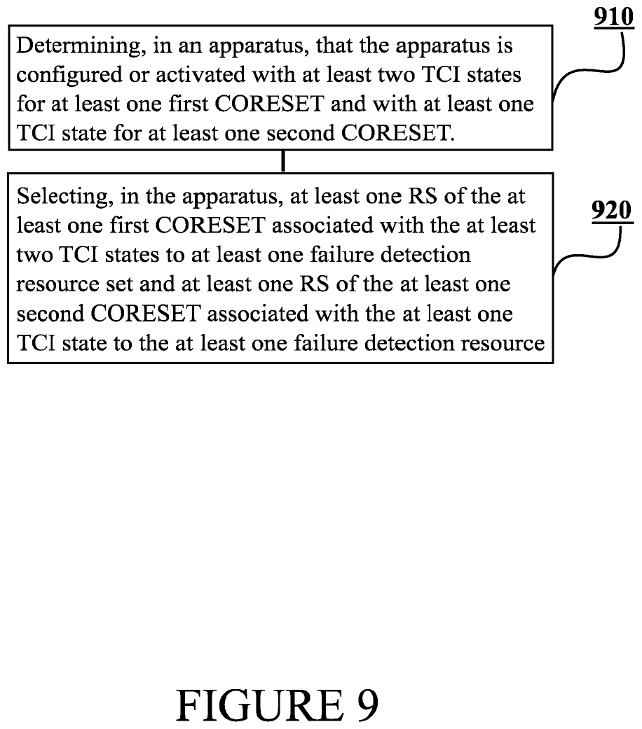

FIG. 9 is a flow graph of a method in accordance with at least some example embodiments. The phases of the illustrated method may be performed by IE 110 or by a control device configured to control the functioning thereof, possibly when installed therein.

The method may comprise, at step 910, determining, in an apparatus, that the apparatus is configured or activated with at least two Transmission Configuration Indicator, TCI, states for at least one first control resource set and with at least one TCI state for at least one second control resource set. The method may also comprise, at step 920, selecting, in the apparatus at least one Reference Signal, RS, of the at least one first control resource set associated with the at least two TCI states to at least one failure detection resource set and at least one RS of the at least one second control resource set associated with the at least one TCI state to the at least one failure detection resource set.

It is to be understood that the example embodiments disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular example embodiments only and is not intended to be limiting.

Reference throughout this specification to one example embodiment or an example embodiment means that a particular feature, structure, or characteristic described in connection with the example embodiment is included in at least one example embodiment. Thus, appearances of the phrases “in one example embodiment” or “in an example embodiment” in various places throughout this specification are not necessarily all referring to the same example embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various example embodiments and examples may be referred to herein along with alternatives for the various components thereof. It is understood that such example embodiments, examples, and alternatives are not to be construed as de facto equivalents of one another, but are to be considered as separate and autonomous representations.

In an example embodiment, an apparatus, such as, for example, UE 110 or wireless network node 120, may comprise means for carrying out the example embodiments described above and any combination thereof.

In an example embodiment, a computer program may be configured to cause a method in accordance with the example embodiments described above and any combination thereof. In an example embodiment, a computer program product, embodied on a non-transitory computer readable medium, may be configured to control a processor to perform a process comprising the example embodiments described above and any combination thereof.

In an example embodiment, an apparatus, such as, for example, UE 110 or wireless network node 120, may comprise at least one processor, and at least one memory including computer program code, wherein the at least one memory and the computer program code are configured to, with the at least one processor, cause the apparatus at least to perform the example embodiments described above and any combination thereof.

Furthermore, the described features, structures, or characteristics may be combined in any suitable manner in one or more example embodiments. In the preceding description, numerous specific details are provided, such as examples of lengths, widths, shapes, etc., to provide a thorough understanding of example embodiments of the disclosure. One skilled in the relevant art will recognize, however, that the disclosure can be practiced without one or more of the specific details, or with other methods, components, materials, etc. In other instances, well-known structures, materials, or operations are not shown or described in detail to avoid obscuring aspects of the disclosure.

While the forgoing examples are illustrative of the principles of the example embodiments in one or more particular applications, it will be apparent to those of ordinary skill in the art that numerous modifications in form, usage and details of implementation can be made without the exercise of inventive faculty, and without departing from the principles and concepts of the disclosure. Accordingly, it is not intended that the disclosure be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some example embodiments find industrial application in cellular communication networks, for example in 3GPP networks, wherein beamforming is used.

### ACRONYMS LIST

3GPP 3rd Generation Partnership Project
BFD Beam Failure Detection
BFR Beam Failure Recovery
BS Base Station
CORESET Control Resource Set
CSI-RS Channel State Information-Reference Signal
CSS Common Search Space
DCI Downlink Control Information
DL Downlink
DPS Dynamic Point Selection
DU Distributed Unit
FeMIMO Further enhanced Multiple-Input Multiple-Output
GSM Global System for Mobile communication
HST High Speed Train
IAB Integrated Access and Backhaul
IoT Internet of Things
LTE Long-Term Evolution
M2M Machine-to-Machine
MT Mobile Terminal
NFC Near-Field Communication
NLOS Non-Line-of-Sight
NR New Radio
PCI Physical Cell Identifier
PDCCH Physical Downlink Control Channel
PUCCH Physical UL Control Channel
QCL Quasi Co-Location
RAN Radio Access Network
RAT Radio Access Technology
RLM Radio Link Monitoring
RRC Radio Resource Control
RS Reference Signal
SFN Single Frequency Network
SSB Synchronization Signal Block
TCI Transmission Configuration Indicator
TRP Transmission and Reception Point
UE User Equipment
UI User Interface
UL UL
WCDMA Wideband Code Division Multiple Access
WiMAX Worldwide Interoperability for Microwave Access
WLAN Wireless Local Area Network

REFERENCE SIGNS LIST

| | |
|---|---|
| 110 | UE |
| 115 | Air interface |
| 120 | Wireless network node |
| 125, 135 | Wired interfaces |
| 130 | Core Network |
| 800-870 | Structure of the apparatus of FIG. 8 |
| 910-920 | Phases of the method in FIG. 9 |

1-15. (canceled)

16. An apparatus comprising at least one processing core, at least one memory including computer program code, the at least one memory and the computer program code configured to, with the at least one processing core, cause the apparatus at least to:
determine that the apparatus is configured or activated with at least two Transmission Configuration Indicator (TCI) states for at least one first control resource set and with at least one TCI state for at least one second control resource set; and
selecting at least one Reference Signal (RS) of the at least one first control resource set associated with the at least two TCI states to at least one failure detection resource set and at least one RS of the at least one second control resource set associated with the at least one TCI state to the at least one failure detection resource set.

17. The apparatus according to claim 16, wherein said selection depends on whether the apparatus is configured, or activated, with one TCI state or more than one TCI state for the at least one second control resource set.

18. The apparatus according to claim 16, wherein said selection depends on whether the apparatus is configured with one failure detection resource set or more than one failure detection resource set.

19. The apparatus according to claim 16, wherein the apparatus is further caused at least to select a maximum number of RSs to the at least one failure detection resource set.

20. The apparatus according to claim 16, wherein the apparatus is further caused at least to:
determine, upon determining the apparatus being configured with one failure detection resource set, that the apparatus is configured or activated with one TCI state for the at least one second control resource set; and
select a RS of the at least one second control resource set associated with said one TCI state to the failure detection resource set, and select a RS of the at least one first control resource set associated with the at least two TCI states to the failure detection resource set.

21. The apparatus according to claim 16, wherein the apparatus is further caused at least to:
determine, upon determining the apparatus being configured with one failure detection resource set, that the apparatus is configured or activated with at least two active TCI states for the at least one second control resource set; and
select a RS per each control resource set to the failure detection resource set.

22. The apparatus according to claim 16, wherein the apparatus is further caused at least to:
determine that the apparatus is configured with more than one failure detection resource set; and
select at least one RS of the at least one first control resource set associated with the at least two TCI states to a failure detection resource set, and select at least one RS of the at least second control resource set associated with the at least one TCI state to another failure detection resource set.

23. The apparatus according to claim 16, wherein the apparatus is further caused at least to:
determine, upon determining the apparatus being configured with more than one failure detection resource set, that at least one of the at least one first control resource set has a same control resource set pool index as at least one of the at least one second control resource set; and
select at least one RS of one of the at least one second control resource set associated with the at least one TCI state to one failure detection resource set first, and then select at least one RS of one of the at least one first control resource set associated with the at least two TCI states to said one failure detection resource set.

24. The apparatus according to claim 16, wherein the apparatus is further caused at least to:
determine, upon determining the apparatus being configured with more than one failure detection resource set, that the apparatus is configured or activated with at least two TCI states for at least two first control resource sets and with one TCI state for at least two second control resource sets; and
select at least one RS of the at least two second control resource sets associated with said one TCI state to a failure detection resource set, and select a RS per each of the at least two first control resource sets associated with the at least two TCI states to another failure detection resource set.

25. The apparatus according to claim 16, wherein the RS is a downlink RS, and the failure detection resource set is a Beam Failure Detection RS set.

26. The apparatus according to claim 16, wherein the RS is a downlink RS, and the failure detection resource set is a Radio Link Monitoring RS set.

27. The apparatus according to claim 16, wherein the second control resource set is associated with one RS and a first physical cell identifier, and the first control resource set is associated with two RSs, and a first of said two RSs is further associated with the first physical cell identifier, and a second of said two RSs is further associated with a second physical cell identifier, and a first failure detection resource set has the RSs associated with the first physical cell identifier, and a second failure detection resource set has the RS associated with the second physical cell identifier.

28. The apparatus according to claim 16, wherein the at least one RS of the at least one first control resource set associated with the at least two TCI states is an RS of a Quasi Co-Location, QCL, type comprising spatial receiver parameters.

29. The apparatus according to claim 16, wherein the apparatus is a user equipment or a control device controlling the user equipment.

30. A method, comprising:
determining, by an apparatus, that the apparatus is configured or activated with at least two Transmission Configuration Indicator (TCI) states for at least one first control resource set and with at least one TCI state for at least one second control resource set; and
selecting, by the apparatus, at least one Reference Signal (RS) of the at least one first control resource set associated with the at least two TCI states to at least one failure detection resource set and at least one RS of the at least one second control resource set associated with the at least one TCI state to the at least one failure detection resource set.

31. The method according to claim 30, further comprising:
determining, upon determining the apparatus being configured with one failure detection resource set, that the apparatus is configured or activated with one TCI state for the at least one second control resource set; and
selecting a RS of the at least one second control resource set associated with said one TCI state to the failure detection resource set, and selecting a RS of the at least one first control resource set associated with the at least two TCI states to the failure detection resource set.

32. The method according to claim 30, further comprising:
determining, upon determining the apparatus being configured with one failure detection resource set, that the apparatus is configured or activated with at least two active TCI states for the at least one second control resource set; and
select a RS per each control resource set to the failure detection resource set.

33. The method according to claim 30, further comprising:
determining that the apparatus is configured with more than one failure detection resource set; and
selecting at least one RS of the at least one first control resource set associated with the at least two TCI states to a failure detection resource set, and selecting at least one RS of the at least second control resource set associated with the at least one TCI state to another failure detection resource set.

34. The method according to claim 30, further comprising:
determining, upon determining the apparatus being configured with more than one failure detection resource set, that at least one of the at least one first control resource set has a same control resource set pool index as at least one of the at least one second control resource set; and
selecting at least one RS of one of the at least one second control resource set associated with the at least one TCI state to one failure detection resource set first, and then selecting at least one RS of one of the at least one first control resource set associated with the at least two TCI states to said one failure detection resource set.

35. The method according to claim 30, further comprising:
determining, upon determining the apparatus being configured with more than one failure detection resource set, that the apparatus is configured or activated with at least two TCI states for at least two first control resource sets and with one TCI state for at least two second control resource sets; and
selecting at least one RS of the at least two second control resource sets associated with said one TCI state to a failure detection resource set, and selecting a RS per each of the at least two first control resource sets associated with the at least two TCI states to another failure detection resource set.
